(19) United States
(12) Patent Application Publication
(10) Pub. No.: US 2017/0279489 A1
(43) Pub. Date: Sep. 28, 2017

(54) TECHNIQUES FOR PROCESSING AND STORING VECTORING COEFFICIENTS

(71) Applicants: QUALCOMM Incorporated, San Diego, CA (US); NOKIA Corporation, Espoo (FI)

(72) Inventors: Shailendra Kumar Singh, Fremont, CA (US); Amitkumar Mahadevan, Edison, NJ (US); Laurent Francis Alloin, Monmouth Beach, NJ (US); Avadhani Shridhar, Santa Clara, CA (US)

(21) Appl. No.: 15/465,370

(22) Filed: Mar. 21, 2017

Related U.S. Application Data
(60) Provisional application No. 62/311,849, filed on Mar. 22, 2016.

(51) Int. Cl. H04B 3/32; H04M 11/06; H04L 12/28

(52) U.S. Cl. CPC H04B 3/32; H04L 12/2878; H04M 11/062

(57) ABSTRACT

Techniques for processing, storing, and using vectoring coefficients in a wireline communication system are disclosed. A wireline device selects victim-disturber specific parameters corresponding to a pair of digital subscriber line (DSL) lines and a subset of tones used to communicate data over the pair of DSL lines and downsamples, based at least in part on a downsampling parameter of the victim-disturber specific parameters, a set of vectoring coefficients. Each set of vectoring coefficients is quantized, and then a set of change values for each set of downsampled and quantized vectoring coefficients is compressed. The set of change values represent a difference between the downsampled and quantized vectoring coefficients across the subset of tones. The wireline device uses the compressed sets of change values to perform vectoring over the DSL lines.

### CROSS REFERENCES

The present application for patent claims priority to U.S. Provisional Patent Application No. 62/311,849 by Singh, et al., entitled “Techniques For Processing and Storing Vectoring Coefficients,” filed Mar. 22, 2016, assigned to the assignee hereof.

### BACKGROUND

The following relates generally to data communications, and more specifically for techniques for processing and storing vectoring coefficients.

The rapid growth of the internet and the content available through the internet has increased the demand for high bandwidth connectivity. Digital subscriber line (DSL or xDSL) technology meets this demand by providing data service over existing twisted pair telephone lines. DSL can be deployed from central offices (COs), from fiber-fed cabinets preferably located near the customer premises, or within buildings. DSL technology achieves higher data transmission rates by taking advantages of unused frequencies, which are significantly higher than voice band frequencies, on the existing twisted pair lines. While current generations of DSL such as VDSL2 extend between 1 and 30 MHz in frequency, the newer generations of DSL systems such as G.FAST lines utilize very high frequency transmission on the order of 1 to 200 MHz in frequency or higher.

DSL systems typically include multiple bundles of twisted pair wires that may be located within close proximity to each other. Because of the high frequencies involved, communication occurring on one wire may degrade or substantially disrupt communication on an adjacent wire by causing electromagnetically induced crosstalk on the adjacent wire. These crosstalk signals on neighboring wires can severely disrupt communications on the impacted wires. Moreover, when a large number of neighboring wires are used in a DSL system, techniques used to mitigate crosstalk signals may become increasingly affected by large amount of data. This increase in data used for communications may thus increase the amount of memory resources and the cost of vectored systems.

### SUMMARY

This disclosure describes techniques for processing and storing vectoring coefficients for use in DSL and other wireline communications. By downsampling, quantizing, compressing, and storing change values of the coefficients on a per-set basis, with each set corresponding to a pair of lines and a subset of tones, vectoring data can be stored efficiently and in a cost-effective manner.

A method of performing wireline communications is disclosed. The method includes selecting victim-disturber specific parameters corresponding to a pair of digital subscriber line (DSL) lines and a set of tones used to communicate data over the pair of DSL lines, downsampling, based at least in part on a downsampling parameter of the victim-disturber specific parameters, a set of vectoring coefficients, quantizing the set of vectoring coefficients based at least in part on a quantization parameter of the victim-disturber specific compression parameters, and compressing, based at least in part on a compression parameter of the victim-disturber specific compression parameters, a set of change values for the downsampled and quantized vectoring coefficients, the set of change values representing a difference between the downsampled and quantized vectoring coefficients across the set of tones. The compressed set of change values may be used to perform vectoring over the pair of DSL lines.

A wireline communication device includes a parameter selector, a downsampler, a quantizer, a compressor, and a compensation block. The parameter selector selects victim-disturber specific parameters corresponding to a pair of digital subscriber line (DSL) lines and a set of tones used to communicate data over the pair of DSL lines. The downsampler downsamples a set of vectoring coefficients based at least in part on a downsampling parameter of the victim-disturber specific parameters. The quantizer quantizes the set of vectoring coefficients based at least in part on a quantization parameter of the victim-disturber specific compression parameters. The compressor compresses, based at least in part on a compression parameter of the victim-disturber specific compression parameters, a set of change values for the set of downsampled and quantized vectoring coefficients, the set of change values representing a difference between the downsampled and quantized vectoring coefficients across the set of tones. The compensation block performs vectoring over the pair of DSL lines using the compressed set of change values.

Another wireline communication device includes means for selecting victim-disturber specific parameters corresponding to a pair of digital subscriber line (DSL) lines and a set of tones used to communicate data over the pair of DSL lines; means for downsampling, based at least in part on a downsampling parameter of the victim-disturber specific parameters, a set of vectoring coefficients; means for quantizing the set of vectoring coefficients based at least in part on a quantization parameter of the victim-disturber specific compression parameters; means for compressing, based at least in part on a compression parameter of the victim-disturber specific compression parameters, a set of change values for the set of downsampled and quantized vectoring coefficients, the set of change values representing a difference between the downsampled and quantized vectoring coefficients across the set of tones; and means for using the compressed sets of change values to perform vectoring over the pair of DSL lines.

A non-transitory computer-readable medium includes computer-readable code that, when executed, causes a wireline communication device to select victim-disturber specific parameters corresponding to a pair of digital subscriber line (DSL) lines and a set of tones used to communicate data over the pair of DSL lines; downsample, based at least in part on a downsampling parameter of the victim-disturber specific parameters, a set of vectoring coefficients; quantize the set of vectoring coefficients based at least in part on a quantization parameter of the victim-disturber specific compression parameters; compress, based at least in part on a compression parameter of the victim-disturber specific compression parameters, a set of change values for the set of downsampled and quantized vectoring coefficients, the set of change values representing a difference between the downsampled and quantized vectoring coefficients across the set of tones; and use the compressed sets of change values to perform vectoring over the pair of DSL lines.

In some examples of the methods, wireline communication devices, or computer-readable medium described above, the downsampling of each set of vectoring coefficients can use a downsampling parameter specific to that set of vectoring coefficients. The downsampling parameter can be selected for each set of vectoring coefficients based at least in part on a variance of that set of vectoring coefficients.

The quantization of each set of vectoring coefficients can use a quantization parameter specific to that set of vectoring coefficients. The quantization parameter can be selected for each set of vectoring coefficients based at least in part on a signal-to-noise ratio (SNR) associated with the set of vectoring coefficients or a downsampling parameter associated with the set of vectoring coefficients.

The compression of the set of change values for each set of vectoring coefficients may use a compression parameter specific to that set of vectoring coefficients. The compression parameter can be selected for each set of vectoring coefficients from a defined set of possible compression parameters. For example, the selection can be based at least in part on a size of the compressed change values when using the selected compression parameter in comparison to at least one other compression parameter from the defined set. In some cases, the set of change values is compressed for each downsampled and quantized vectoring coefficients using a codeword based compression. A codeword assignment for each change value can be determined using a Golomb-Rice encoding scheme, and the codeword assignment can be changed for at least one of the change values based at least in part on a frequency of occurrence of the change value and a size of a codeword originally assigned to that change value using the Golomb-Rice encoding scheme.

In some examples, the pair of DSL lines can be a victim-disturber pair.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

FIG. 1 is an example of a network configuration, which may be configured for communicating data, with CPEs communicatively coupled to a DSLAM via a cable bundle;

FIG. 2 illustrates an example of data communications system that supports techniques for processing and storing vectoring coefficients in accordance with aspects of the present disclosure;

FIG. 3 illustrates an example of a coefficient array in a system that uses vectoring for techniques for processing and storing vectoring coefficients in accordance with various aspects of the present disclosure;

FIGS. 4A and 4B illustrate examples of network subsystems configured for techniques for processing and storing vectoring coefficients in accordance with various aspects of the present disclosure;

FIG. 5 illustrates an example of a CO apparatus configured for techniques for processing and storing vectoring coefficients accordance with various aspects of the present disclosure; and

FIGS. 6 and 7 illustrate methods for techniques for processing and storing vectoring coefficients in accordance with various aspects of the present disclosure.

### DETAILED DESCRIPTION

Some digital subscriber line (DSL) communications systems may use vectoring to decrease the effects of interference that occurs among multiple lines. That is, vectoring may enable coordinated communication between twisted pairs of DSL lines sharing a same cable binder to mitigate far end crosstalk (FEXT). The coordination may be enabled by a DSL access multiplexer (DSLAM) where the twisted pairs terminate. To accomplish vectoring, the DSLAM may pre-code signals that are transmitted, and correspondingly decode signals that are received, via a transceiver for every tone (frequency) used by devices in the network. The FEXT precoding and FEXT cancellation may be accomplished using crosstalk matrix coefficients (e.g., for precoder and postcoder or cancelling matrices) associated with the pairs of a vectored group, such as victim pairs (e.g., pairs that are subject to the interference by other pairs) and disturber pairs (e.g., pairs that cause interference to victim pairs).

The number of coefficients stored for FEXT precoding and cancellation may significantly increase as the number of vectored lines in a vectored group increase. In some cases, this may lead to such large number of coefficients that it becomes inefficient and cost prohibitive to store the amount of corresponding data, and the number of coefficients may be too large to use for real-time vectoring computations.

Some communications systems may use a coefficient compression scheme to enable efficient vectoring, where the coefficient compression scheme may use downsampling, quantization, and the encoding of a change value to store compressed codewords. For example, a system may use downsampling (e.g., decreasing a sampling rate to keep every nth sample) to store the coefficients associated with certain tones or sub-bands. The downsampled coefficients may then be quantized (e.g., mapping inputs within a specific range to a common value). Following quantization, a change value representing a difference between the different coefficients may be generated. The change value may subsequently be encoded using lossy compression techniques (e.g., Golomb Rice encoding) and stored as a compressed codeword. For each victim, the coefficients of multiple contiguous tones (sub-bands) are grouped together for compression.

Conventional schemes for compressing disturber vectoring coefficients are inefficient. In many instances, one or more disturber coefficients of a canceller victim-disturber pair experiences large variations in a sub-band. Conventionally, all disturber coefficients of multiple contiguous tones (sub-bands) are grouped together and compressed using a set of parameters, Fsub, parameter k, and Golomb modulus M having common values for all victim-disturber pairs. Thus, disturber coefficients for all victim-disturber pairs in the sub-band are downsampled using a same value for the downsampling parameter, quantized using a same value for the quantization parameter, and encoded using a same value for the encoding modulus. Using the same parameter values to compress all disturber coefficients of a sub-band fails to account for these large variations, resulting in inefficient compression of the disturber coefficients.

In the examples described herein, downsampling, quantization, and encoding of a change value may be achieved through tailoring a downsampling parameter (e.g., Fsub), a quantization parameter (e.g., a parameter k), and an encoding modulus (e.g., Golomb modulus, M), respectively, to each victim disturber pair. These parameters may be selected for victim disturber pairs for each tone or sub-band found in a coefficient array. Additionally, the downsampling, quantization, and encoding parameters may not be used for every tone in a band. That is, a number of tones may be divided into sets of tones, or sub-bands, and parameters may be selected for the sub-bands. In some cases, a codeword encoded by a Golomb modulus may be reassigned to a different value, to a larger codeword, or both, to optimize the encoding of the change values. In some cases, a codeword assignment table may be maintained to track codeword reassignments. The codeword assignment table may define per-victim and per-sub-band parameters (e.g., Fsub, k, and M parameters) and may store the selected parameters.

In the examples described herein, victim disturber-specific values for a set of parameters (Fsub, k and M) are selected for each victim disturber pair in each sub-band. Disturber vectoring coefficients of each victim disturber pair in each sub-band are compressed using the victim disturber-specific values for the set of parameters (Fsub, k and M). Coefficient compression is thus more effective because the set of parameters are tailored to vectoring coefficients of each disturber. The compression techniques thereby may more effectively compress disturber vectoring coefficients by accounting for large variations of one or more disturber coefficients within a subband. Moreover, the compression techniques described herein beneficially reduce the amount of memory required to store codewords of compressed disturber vectoring coefficients to achieve a target data rate performance, signal to noise ratio (SNR) performance, and/or the like.

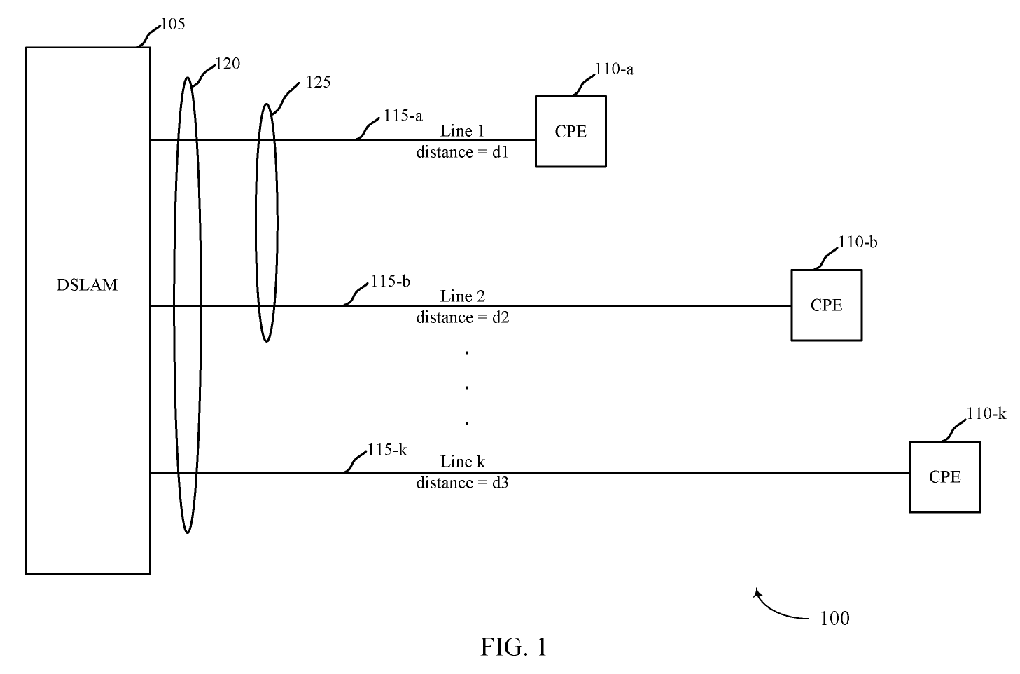

FIG. 1 illustrates an example of a network configuration 100. The configuration comprises a DSLAM 105 that is connected to a number of remote nodes, such as consumer-premises equipment (CPEs) 110, via a cable bundle 120 comprising one or more sub-bundles 125. In some cases, DSLAM 105 may be located at a central office (CO) (not shown). The CPEs 110 are communicatively coupled to the DSLAM 105 via respective subscriber lines denoted 115-a, 115-b, through to 115-k. Each of the lines 115-a, 115-b, and 115-k include, for example, one or more twisted-pair copper wire connections. The CPEs 110 are located at various distances (d1, d2, d3) from DSLAM 105. A given CPE 110 may comprise, by way of example, a modem, a computing device, or other types of communication devices, or combinations of such devices which are configured to receive data from a DSLAM 105.

Communications between the DSLAM 105 and the CPEs 110 include both downstream and upstream communications for each of the active lines. The downstream direction refers to the direction from DSLAM 105 to CPE 110, and the upstream direction is the direction from CPE 110 to DSLAM 105. Although not explicitly shown in FIG. 1, each of the subscriber lines 115 of network configuration 100 includes a DSLAM transmitter and a CPE receiver for use in communicating in the downstream direction, and a CPE transmitter and a DSLAM receiver for use in communicating in the upstream direction. On both the DSLAM 105 and CPE 110 side, hardware implementing both a transmitter and a receiver is generically referred to as a modem.

Because different lines 115 are in close proximity with each other in cable bundles 120 and sub-bundles 125, these lines 115 can be susceptible to crosstalk interference. Hence, data signals transmitted on neighboring or close-proximity lines 115 can be superimposed on and contaminate each other. Based at least in part on such crosstalk, data signals transmitted over the lines 115 can be considerably degraded by the crosstalk interference generated on one or more adjacent lines 115 in the same and/or a nearby multi-core cable or bundle 120. Accordingly, a transmission on one subscriber line 115 may be detected on other subscriber lines 115.

To help ameliorate the issue of transmitting and receiving data on a line 115 that has been compromised by crosstalk interference, network configuration 100 may use vectoring to decrease the effects of interference that occurs among multiple lines 115. That is, vectoring may enable coordinated communication between twisted pairs of DSL lines sharing a same cable binder to mitigate FEXT. The coordination may be enabled by DSLAM 105 where the twisted pairs of lines 115 terminate. To accomplish vectoring, DSLAM 105 may pre-code signals that are transmitted, and correspondingly decode signals that are received, via a transceiver for every tone (frequency) used by devices in the network. The FEXT precoding and FEXT cancellation may be accomplished using vectoring coefficients associated with the pairs of a vectored group, such as victim pairs (e.g., pairs that are subject to the interference by other pairs) and disturber pairs (e.g., pairs that cause interference to victim pairs).

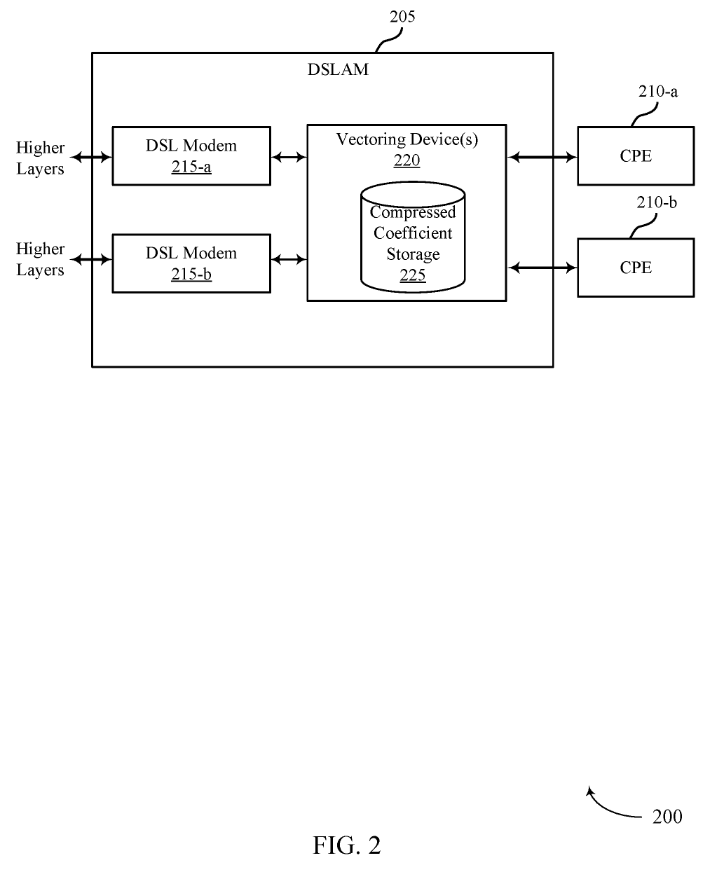

FIG. 2 illustrates an example of a data communications system 200 that supports techniques for processing and storing vectoring coefficients. Data communications system 200 may include DSLAM 205, CPE 210-a, and CPE 210-b which may be examples of the corresponding devices described with reference to FIG. 1. DSLAM 205 may include various components in communication with each other, including DSL modem 215-a, DSL modem 215-b, and vectoring device(s) 220. Vectoring device(s) 200 may transmit and receive vectored signals to and from one or more CPE 210, and may use compressed vectoring coefficients to determine how to pre-code and post-code the data streams. The compressed vectoring coefficients may be stored in compressed coefficient storage 225. Data communications system 200 may illustrate an example of using coefficient compression with victim and disturber based parameters.

Data communications system 200 may use a coefficient compression scheme to enable efficient vectoring, where the coefficient compression scheme may use downsampling, quantization, and the encoding of a change value to store compressed codewords. For example, higher layer communication data may be received at DSL modem 215-a and DSL modem 215-b. The communication data may then be transmitted to vectoring devices(s) 220. Vectoring device(s) 220 may subsequently use downsampling (e.g., decreasing a sampling rate to keep every nth sample) on coefficients associated with certain tones or sub-bands (e.g., only the 1st, 4th, and 8th tone may be stored). The downsampled coefficients may then be quantized (e.g., mapping inputs within a specific range to a common value). Following quantization, a change value representing a difference between different coefficients may be generated, such as the difference between the downsampled and quantized coefficients across a set of tones (or frequency axis). The change value may subsequently be encoded using lossy codeword based compression techniques (e.g., Golomb Rice encoding) and stored as a compressed codeword. A vectored signal may then be transmitted over multiple DSL lines to multiple CPEs 210, such as CPE 210-a and CPE 210-b. Vectored upstream signals received from CPE 210-a and CPE 210-b may be received by vectoring devices(s) 220, and may be demodulated and postcoded based on the stored compressed coefficients.

In some cases, downsampling, quantization, and encoding of a change value may be achieved through the use of a downsampling parameter (e.g., F sub), a quantization parameter (e.g., the parameter k), and a compression parameter (e.g., a Golomb modulus M), respectively. These parameters may be selected based on victim and disturber pairs for each tone or sub-band found in a coefficient array. Additionally, the parameters may be used to compress and decompress the stored codewords, and therefore the coefficients, in real time.

In some examples, the downsampling parameter may depend on a variation in the coefficients being downsampled. For example, if the coefficients are highly variable, a smaller downsampling parameter may be used. Additionally, if the coefficients do not vary then a larger downsampling parameter may be used to minimize interpolation noise (e.g., errors introduced by downsampling processes). Vectoring device(s) 220 may, for example, calculate a statistical variance to determine whether one or more thresholds are satisfied. Vectoring device(s) 220 may determine that coefficients are highly variable if the statistical variance exceeds a threshold, and may determine that coefficients are less variable if the statistical variance is at or below the threshold. In some examples, values of a downsampling parameter may correspond to respective non-overlapping variance ranges, and the vectoring device(s) 220 may select the downsampling parameter value based at least in part on in which range a measured variance falls. Vectoring device(s) 220 also may select the downsampling parameter value from a defined set of values for the downsampling parameter.

The quantization parameter may be used indicate the size of the coefficient array (e.g., how may bits to keep through quantization) and may also be based on a signal to noise ratio (SNR), the amount of downsampling, or both. For example, a lower SNR may correspond to a higher quantization parameter, such as when background noise may be greater than quantization noise (e.g., errors introduced by quantization processes). In another example, a large amount of downsampling may also correspond to a smaller quantization parameter, such as when there may not be a large variation in coefficients as discussed above. In some cases, the downsampling parameter and the quantization parameter may be selected to keep interpolation noise and quantization noise, respectively, below a background noise level. Vectoring device(s) 220 may, for example, measure SNR to select a value of the quantization parameter based at least in part on a comparison to one or more SNR thresholds. Vectoring device(s) 220 may select a first value for the quantization parameter if a measured SNR exceeds a SNR threshold, and may select a second value for the quantization parameter if a measured SNR is at or below the threshold. In some examples, values of a quantization parameter may correspond to respective non-overlapping SNR ranges, and the vectoring device(s) 220 may select the quantization parameter value based at least in part on inwhich range the measured SNR falls. Vectoring device(s) 220 also may select the quantization parameter value from a defined set of values for the quantization parameter.

The compression parameter, such as the Golomb modulus, may be based at least in part on a value of the modulus M that achieves a desired compression size (e.g., a smallest compression size). For example, after change values are encoded using different Golomb modulus values, a codeword length estimate may be used to determine how much storage may be used corresponding to each of the values. The Golomb modulus that provides a smallest codeword length may then be selected from the set of moduli. In some cases, the use of the victim and disturber based pairs for coefficient compression may be used for each discrete multitoned (DMT) symbol.

In some examples, the downsampling, quantization, and encoding parameters may not be used for every tone in a band. For each victim, the coefficients of multiple contiguous tones (sub-band) may be group together for compression. That is, a number of tones may be divided into sets of tones, or sub-bands, and parameters may be selected for the sub-bands. For example, in a band of 2048 tones, these tones may be divided into 8, 12, or 16 different sub-bands. As a result, when the whole band is divided into a certain number of sub-bands and the parameters may be selected for each band associated with the victim and disturber pair. For each victim pair's (including all disturber pairs) coefficient compression parameters (Fsub, k and M) may be selected on a per sub-band basis such that the compressed coefficient may meet a memory budget with a least amount of degradation in the data rate performance, such as determined by the SNR. The stored codewords may be packed for efficient storage and subsequent coefficient reconstruction. In some cases, coefficient reconstruction may include unpacking encoded bits for decoding (e.g., Golomb decoding) and reconstruction. In some cases, the decoding may use a Golomb modulus value, and interpolation using the quantization parameter Fsub and upscaling using the downscaling parameter k may be used to reconstruct the coefficients.

In some examples, vectoring devices 220 may be used for the packing and unpackaging of bits. In some examples, when downsampling using a single coefficient memory for all disturber pairs (e.g., disturber pairs of DSL lines 565), the order in which the coefficients may be stored would be in an order determined by hardware.

The following packing table provides examples of the order in which coefficients may be packed in memory.

| | | | | | | | | | | |
|---|---|---|---|---|---|---|---|---|---|---|
| P0Fsub2, | . . . | C_P0_T16 | C_P1_16 | C_P0_T18 | C_P1_18 | C_P0_T20 | C_P1_20 | C_P0_T22 | C_P1_22 | . . . |
| P1Fsub2 | | | | | | | | | | |
| P0Fsub4, | . . . | C_P0_T16 | C_P1_16 | C_P0_T20 | C_P1_20 | C_P0_T24 | C_P1_24 | C_P0_T28 | C_P1_28 | . . . |
| P1Fsub4 | | | | | | | | | | |
| P0Fsub2, | . . . | C_P0_T16 | C_P1_16 | C_P0_T18 | C_P0_20 | C_P1_T20 | C_P0_22 | C_P0_T24 | C_P1_24 | . . . |
| P1Fsub4 | | | | | | | | | | |
| P0Fsub4, | . . . | C_P0_T16 | C_P1_16 | C_P1_T18 | C_P0_20 | C_P1_T20 | C_P1_22 | C_P0_T24 | C_P1_24 | . . . |
| P1Fsub2 | | | | | | | | | | |

For example, in some cases there may be two ports (e.g., port0 (PO) and port1 (P1)), both with a downsampling parameter equal to a certain value (e.g., Fsub=2), and a first tone equal to a certain frequency (e.g., 16). In the coefficient memory, the order of values may be C_P0_T16, C_P1_T16, C_P0_T18, C_P1_T18, C_P0_T20, C_P1_T20, where C_Pj_Tk represents the coefficient difference for port ‘j’ and tone ‘k’. In some cases, if both had a down sampling parameter equal to a greater value (e.g., Fsub=4), the order may be C_P0_T16, C_P1_T16, C_P0_T20, C_P1_T20, C_P0_T24, C_P1_T24, . . . .

In some examples, if port0 has Fsub=2, and port1 has Fsub=4, the order may be C_P0_T16, C_P1_T16, C_P0_T18, C_P0_T20, C_P1_T20, C_P0_T22, C_P0_T24, C_P1_T24, . . . . Alternately, if port0 has Fsub=4, and port1 has Fsub=2, the order may be C_P0_T16, C_P1_T16, C_P1_T18, C_P0_T20, C_P1_T20, C_P1_T22, C_P0_T24, C_P1_T24, . . . . In some examples, with two bits per disturber indicating which of the Fsub (out of three possible Fsubs) parameters to use, the reconstruction of coefficients may know which of the parameter and state register to use for the disturber being processed.

In some cases, a codeword encoded by a Golomb modulus may have variable lengths. For example, a Golomb code may be based on a probability of values, and small values may be more likely to occur than larger values. As a result, the codewords may be reassigned to optimize the encoding of the change values. For example, the smallest codewords may be assigned to the change values that occur most frequently. Alternately and/or additionally, the least frequent change values may be reassigned to a larger codeword. In some cases, a codeword assignment table may be maintained to track the codeword assignments. A codeword assignment table may also be referred to as a codeword redistribution table.

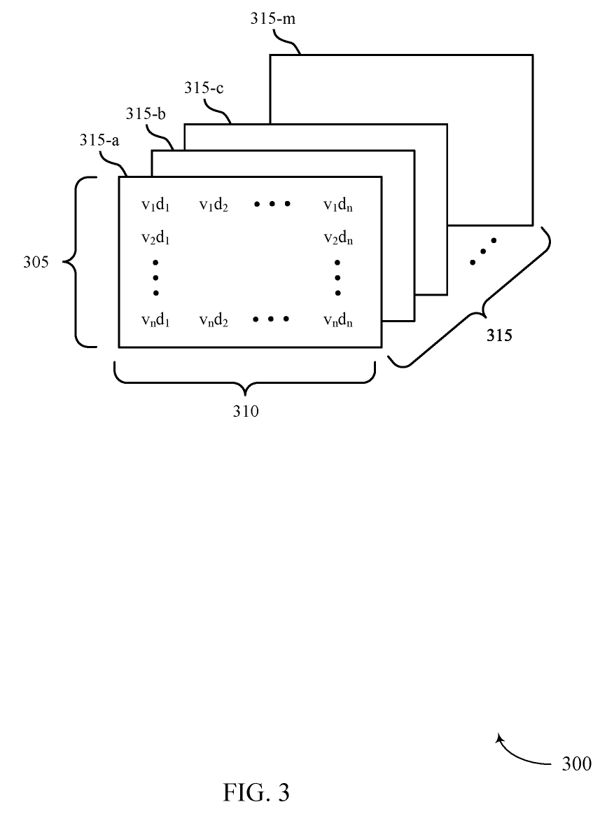

FIG. 3 illustrates an example of a coefficient array 300 in a system that uses vectoring for techniques for processing and storing vectoring coefficients. Coefficient array 300 may be stored and used by one or more vectoring devices 220 for FEXT precoding of a downstream signal. Additionally, coefficient array 300 may be used in the upstream direction in the FEXT cancellation of demodulated symbols.

Coefficient array 300 may include a first axis 305 indicating rows of victim pairs, such as twisted pairs that are subject to interference from adjacent or other twisted pairs. A second axis 310 may represent columns of disturber pairs, such as twisted pairs that cause interference to the corresponding victim pairs. A third axis 315 may represent tones or frequencies in a band used for communications. Additionally or alternatively, the third axis may represent groups of tones or sub-bands associated with each victim/disturber pair.

In some examples, the downsampling parameters, quantization parameters, or encoding moduli may be selected for pairs of victims and disturbers. For example, a first set of parameters (e.g., Fsub, k, M) may be selected for a first victim/disturber pair in coefficient array 300 (e.g., represented as v₁d₁) along with a set of tones or sub-bands (e.g., tones 315-a, 315-b, 315-c, . . . 315-m) associated with the first victim disturber pair (e.g., v₁d₁ for tone 315-a on the third axis 315). In some cases, the set of parameters may be selected for each row of victims for all disturbers. For example, in a first row of coefficient array 300 (e.g., v₁d₁, v₁d₂, . . . v₁dₙ), the coefficients of all disturbers and a certain number of tones may be used to select a single set of parameters, such as a downsampling parameter, a quantization parameter, and a compression coefficient or Golomb modulus. In some cases there may be an equal number of parameters as there are disturbers in coefficient array 300.

For a given victim and sub-band (e.g., victim v₁ and sub-band 315-a), victim disturber-specific values may be selected for a set of parameters (e.g., v₁d₁) and used for compressing of vectoring coefficients specific to a victim disturber pair in that sub-band. In an example, separate downsampling parameters, quantization parameters, and compression coefficient parameters may be selected for compressing vectoring coefficients for each victim disturber pair. The following describes a coefficient compression process for compressing vectoring coefficients of a single disturber, and the coefficient compression process may be repeated for vectoring coefficients of each disturber. Vectoring devices 220, or any other device, may perform the coefficient compression process described below.

Initially, a particular victim disturber pair may be selected and a disturber's vectoring coefficients associated with the particular victim disturber pair may be identified. The disturber's vectoring coefficients may be downsampled using a victim disturber-specific value of a downsampling parameter (e.g., compress using Fsub value specific to a victim disturber pair). The value of the downsampling parameter may depend on, for example, a variation in the coefficients being downsampled. The disturber's downsampled vectoring coefficients may be downscaled using a victim disturber-specific value of a quantization parameter (e.g., downscale using value of k parameter specific to each victim disturber pair). The value of the quantization parameter may depend on, for example, an identified SNR.

Then, a set of change values may be determined for each set of downsampled and downscaled disturber vectoring coefficients. The set of change values may represent a difference between the downsampled and quantized vectoring coefficients across a set of tones (or frequency axis). The set of change values may subsequently be encoded using lossy compression techniques (e.g., Golomb Rice encoding) and stored as a compressed codeword. For example, Golomb encoding, using a victim disturber-specific value of a Golomb-modulus (e.g., value of the M parameter for the victim disturber pair), may be used to compress and encode the downsampled and downscaled disturber vectoring coefficients to generate codewords representing one or more change values for each set of downsampled and quantized vectoring coefficients.

In some cases, a codeword encoded by a Golomb modulus may have variable lengths, and a codeword assignment table may be maintained to track reassignment of the codewords. For example, unary codewords generated by Golomb encoding may be reassigned and the reassignment may be maintained in the assignment table. The codewords, including any reassigned unary codewords, may be packed for efficient storage in memory.

A reconstruction process also may use the set of parameters to reconstruct disturber vectoring coefficients for a victim disturber pair from the packed codewords. The following describes a reconstruction process for reconstructing vectoring coefficients of a single disturber, and the reconstruction process may be repeated for vectoring coefficients of each disturber. Vectoring devices 220, or any other device, may perform the reconstruction process described below.

Initially, a victim disturber pair in a subband may be identified and codewords corresponding to the victim disturber pair may be retrieved from memory. Golomb decoding, using a victim disturber-specific value of a Golomb-modulus (e.g., value of the M parameter for the victim disturber pair), may be performed on the retrieved codewords as per the Golomb codeword assignment table to generate downsampled and downscaled disturber vectoring coefficients. Upscaling, using a victim disturber-specific value of the quantization parameter (e.g., disturber specific value of the k parameter), may be performed on the downsampled and downscaled disturber vectoring coefficients to obtain downsampled disturber vectoring coefficients. Interpolation, using a victim disturber-specific value of the downsampling parameter (e.g., disturber specific value of the Fsub parameter), may be performed on the downsampled disturber vectoring coefficients to reconstruct the disturber vectoring coefficients. Vectoring devices 220 may use the reconstructed disturber vectoring coefficients to perform vectoring over the victim disturber pair of DSL lines.

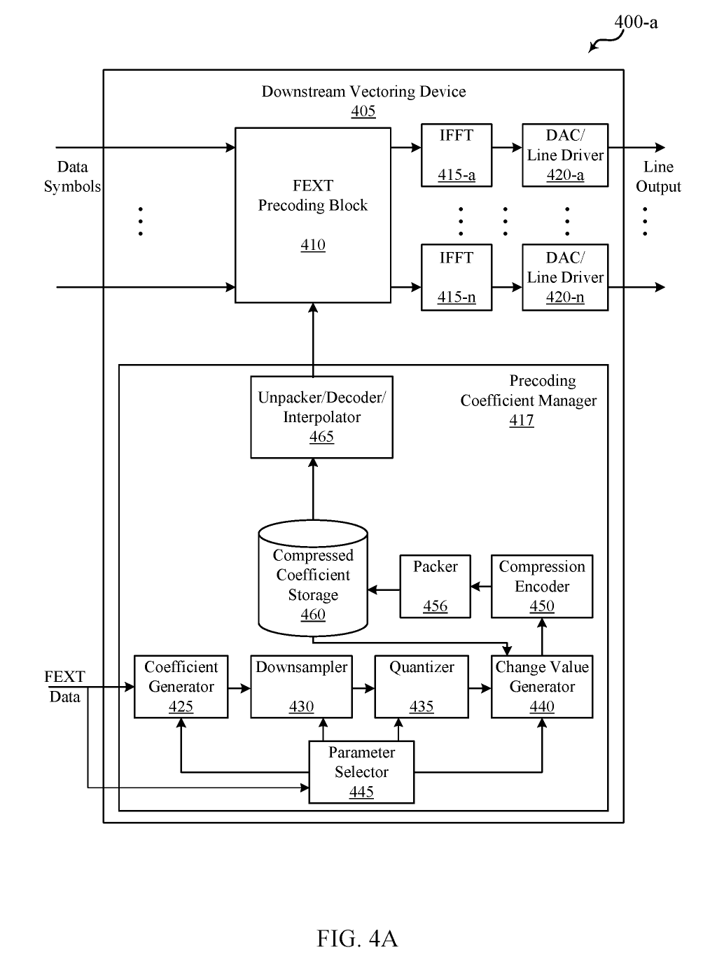

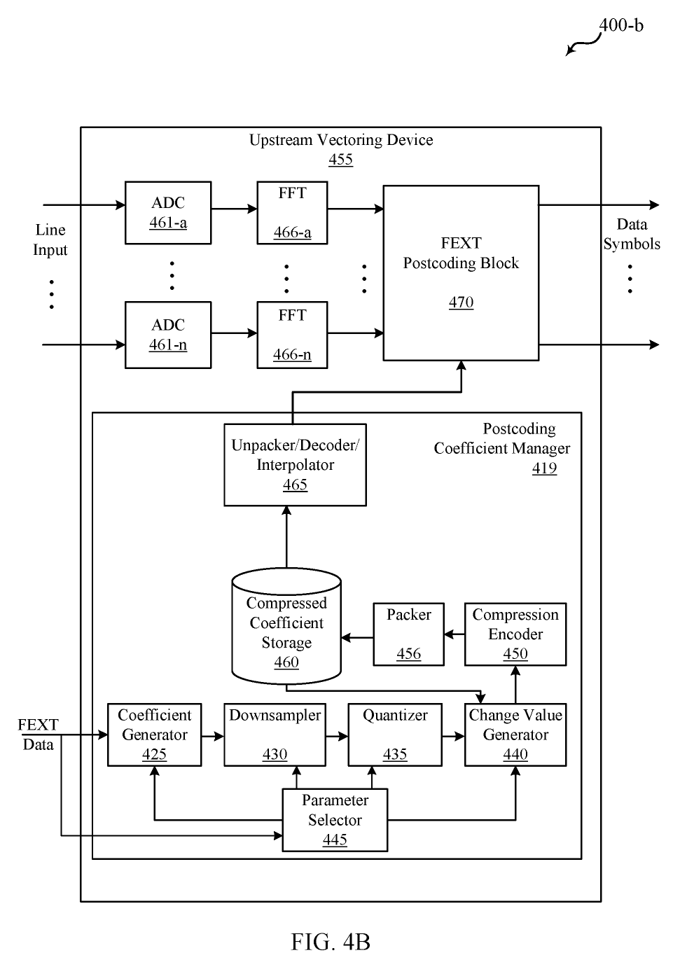

FIG. 4A shows an example of a downstream vectoring operation 400-a using a downstream vectoring device 405, and FIG. 4B shows an example of an upstream vectoring operation 400-b using an upstream vectoring device 455. The downstream vectoring device 405 and the upstream vectoring device 455 may be implemented separately or as a single device that performs vectoring in both directions. The downstream vectoring device 405 and the upstream vectoring device 455 are examples of the vectoring device(s) 220 shown in FIG. 2.

Turning specifically, to FIG. 4A, in the downstream direction, a number of data symbols (e.g., data symbols according to a quadrature amplitude modulation (QAM) or other modulation scheme) from a number of DSL modems, such as the DSL modems 215 of FIG. 2, are received by a far-end cross talk (FEXT) precoding block 410, which precodes or “vectors” the data symbols for all of the modems on a per-tone basis using stored vectoring coefficients obtained from a precoding coefficient manager 417. The FEXT precoding block 410 also may be referred to as a compensation block. The outputs of the FEXT precoding block 410 are fed to individual inverse Fast Fourier Transform (IFFT) blocks 415-a to 415-n and digital-to-analog conversion (DAC)/line driver blocks 420-a to 420-n for each DSL modem to transmit the precoded signals on physical DSL lines.

The precoding coefficient manager 417 updates the vectoring coefficients used by the FEXT precoding block 410. When FEXT measurements are performed on the DSL lines, a coefficient generator 425 receives FEXT data corresponding to the measurements and converts the FEXT data to vectoring coefficients using cross-talk cancellation computations. With reference to FIG. 3, these vectoring coefficients can be represented in the coefficient array 300 as a three-dimensional array with one dimension representing victim lines (axis 305), another dimension representing disturber lines (axis 310), and a third dimension representing frequency tones (axis 315). As discussed previously, the frequency tones can be further grouped into subsets (also referred to as subbands). In such cases, one way of organizing the data in the three-dimensional array of vectoring coefficients is as a plurality of sets of vectoring coefficients, with each set of vectoring coefficients corresponding to a victim-disturber pair of DSL lines and a subset of the frequency tones. In some cases, a subset of tones may include as few as a single tone.

The vectoring coefficients are provided to a downsampler 430 which performs downsampling on a per-set basis. The downsampling parameter Fsub (also referred to as a “downsampling factor”) for each set or subset is chosen by a parameter selector 445. For example, the parameter selector 445 can determine the variance in the vector coefficients for an individual set and assign lower downsampling factors to sets with less variation in the vector coefficients and higher downsampling factors to sets having more variation in the vector coefficients.

Following downsampling, a quantizer 435 quantizes the downsampled vector coefficients to a number of bits selected on a per-set basis by the parameter selector 445. The parameter selector 445 can choose the number of bits for quantization based at least in part on a SNR measured for the victim-disturber pair and subset of tones corresponding to an individual set. For relatively low SNRs (as measured by a threshold or some other criterion), higher quantization parameters may be selected for the set (i.e. more bits are used to represent the downsampled vector coefficients) to prevent quantization noise from dominating background noise. Additionally or alternatively, the downsampling parameter Fsub of the downsampler 430 can be used as a basis for selecting the quantization parameter. Smaller values of the downsampling parameter Fsub can indicate lower amounts of variation in the vector coefficients for the set, and therefore allow for the use of fewer bits to represent the vector coefficients for that set.

Following quantization, a change value generator 440 determines the difference between the downsampled and quantized sets of vector coefficients across the tones (or frequency axis generates sets of change values representing the difference between the downsampled and quantized vector coefficients across a set of tones (or frequency axis).

The change values are then provided to a compression encoder 450 which encodes the change values using codeword-based compression encoding, such as Golomb-Rice encoding. For Golomb-rice encoding, the Golomb modulus M can be selected on a per-set basis. The Golomb modulus M is selected, for example, from a finite set of possible M values by performing the encoding using each possible value of M, then selecting the M value that performs the best compression of a particular set of change values. In addition, codeword reassignment can occur to further optimize compression as described elsewhere in this disclosure. Following compression encoding, a packer 456 packs the encoded bits for efficient storage and reconstruction considering the set-specific downsampling parameter. In some examples, packer 456 may pack the encoded bits in the order specified in the packing table. Details of this packing are described elsewhere in this disclosure.

The packed, compressed, change values representing different sets of downsampled and quantized vector coefficients are stored in the compressed coefficient storage 460. The compressed coefficient storage 460 may be an array or other data structure stored on physical memory. When vectoring coefficients are provided to the FEXT precoding block 410, an unpacker/decoder/interpolator 465 performs unpacking, decoding, and interpolation to approximate the vectoring coefficients originally generated by coefficient generator 425. In some examples, unpacker/decoder/interpolator 465 may unpack the encoded bits in the order specified in the packing table.

Turning specifically to FIG. 4B, in the upstream direction, analog-to-digital conversion (ADC) blocks 461-a to 461-n and Fast Fourier Transform (FFT) blocks 466-a to 466-n receive a number of data symbol streams corresponding to a number of different DSL lines. The received data symbols are fed to a FEXT postcoding block 470, which postcodes or “vectors” the data symbols for all of the DSL lines on a per-tone basis using stored vectoring coefficients obtained from a postcoding coefficient manager 419. The outputs of the FEXT postcoding block 470 are fed to individual DSL modems (not shown) corresponding to the different lines for demodulation and transmission to higher layers.

The postcoding coefficient manager 419 contains a coefficient generator 425, downsampler 430, quantizer 435, change value generator 440, parameter selector 445, compression encoder 450, packer 456, compressed coefficient storage 460, and unpacker/decoder/interpolator 465. These blocks perform substantially the same functions as described above with respect to FIG. 4A, but from the perspective of post-compensation of uplink data symbols.

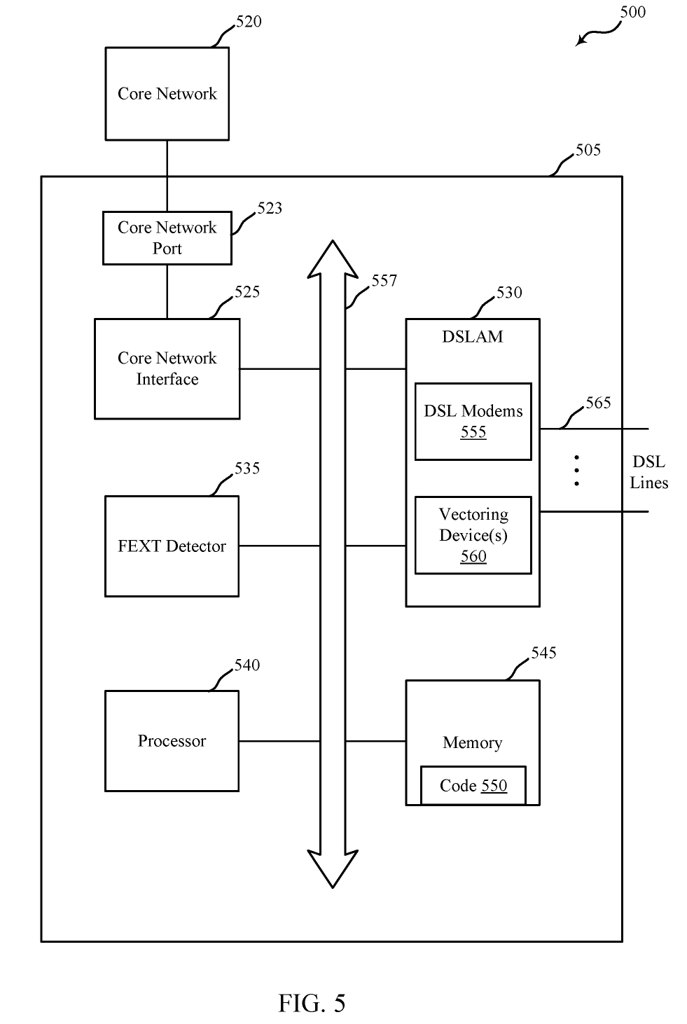

FIG. 5 shows a block diagram 500 of a central office (CO) apparatus 505 for use in techniques for processing and storing vectoring coefficients in accordance with various aspects of the present disclosure. The CO apparatus 505 may include a core network port 523, core network interface 525, digital subscriber line access multiplexer (DSLAM) 530, FEXT detector 535, processor 540, and a memory 545. Each of these components may be in communication with each other, directly or indirectly, over one or more buses 557.

Core network interface 525 communicates various data and controls with bus 557 and core network 520 via core network port 523. The core network 320 may provide access authorization, tracking, Internet Protocol (IP) connectivity, and other access, routing, or communications functions.

DSLAM 530 may route DSL connections established to the Internet via the core network 520. DSLAM 530 combines a group of DSL connections associated with different lines and DSL ports into one aggregate Internet connection. For example, DSLAM 530 may receive signals from all the CPEs in a certain neighborhood via pairs of DSL lines 565 and patch them through to the Internet backbone. The DSLAM 530 processes each incoming connection and, in some cases, limits the bandwidth of certain DSL lines. Multiple DSLAMs 530 may be deployed to help route incoming and outgoing traffic in the most efficient way possible. DSLAM 530 may include DSL modems 555 and vectoring device(s) 550, which may represent examples of the devices described with reference to FIG. 2.

DSL modems may send communications signals from core network 520, code network port 523, and code network interface 525. In DSL modems may also transmit vectored signals to multiple CPEs 110 over DSL lines 565. In some cases, vectoring device(s) 560 may perform vectoring operations using compressed coefficients in accordance with various aspects of the disclosure. For example, vectoring device(s) 560 may downsample a plurality of vectoring coefficients, where each set of vectoring coefficients may be associated with a pair of DSL lines 565 and a subset of tones used to communicate data over the pair of DLS lines 565. In some cases, vectoring device(s) 560 may quantize each set of vectoring coefficients and compress a set of change values for each set of downsampled and quantized vectoring coefficients. In some cases the set of change values may represent a difference between the downsampled and quantized vectoring coefficients across the tones or frequency axis. Vectoring device(s) 560 may use the compressed sets of change values to perform vectoring over the DSL lines 565. Vectoring device(s) 560 also may be used for the packing and unpacking of bits. The Vectoring device(s) 560 may unpack bits, and perform upscaling and interpolation on the unpacked bits, to construct vectoring coefficients and use the vectoring coefficients for vector processing. In some cases, downsampling, quantization, and compression may be performed by vectoring device(s)s 560, or other hardware or processors.

FEXT detector 535 may identify a vectoring coefficient compression scheme in accordance with various aspects of the present disclosure. That is, FEXT detector 535 may identify the presence of FEXT and determine that vectoring coefficients may be compressed, such as using vectoring device(s) 560. FEXT detector 535 may receive various measured parameters over one or more DSL lines 565.

Processor 540 is an intelligent hardware device, e.g., a CPU, a microcontroller, an applications specific integrated circuit (ASIC), etc. Processor 540 processes information received through the core network port 523, core network interface 525, and/or DSLAM 530. Processor 540 may also process information to be transmitted via these blocks. Processor 540 may handle, alone or in connection with the FEXT detector 535, various aspects of phantom link detection.

Memory 545 may include random access memory (RAM) and/or read-only memory (ROM). Memory 545 may store computer-readable, computer-executable software/firmware code 550 containing instructions that are configured to, when executed, cause processor 540 to perform various functions described herein related to phantom link detection. Alternatively, the computer-readable, computer-executable software/firmware code 550 may not be directly executable by processor 540 but be configured to cause CO apparatus 505 (e.g., when compiled and executed) to perform various functions described herein.

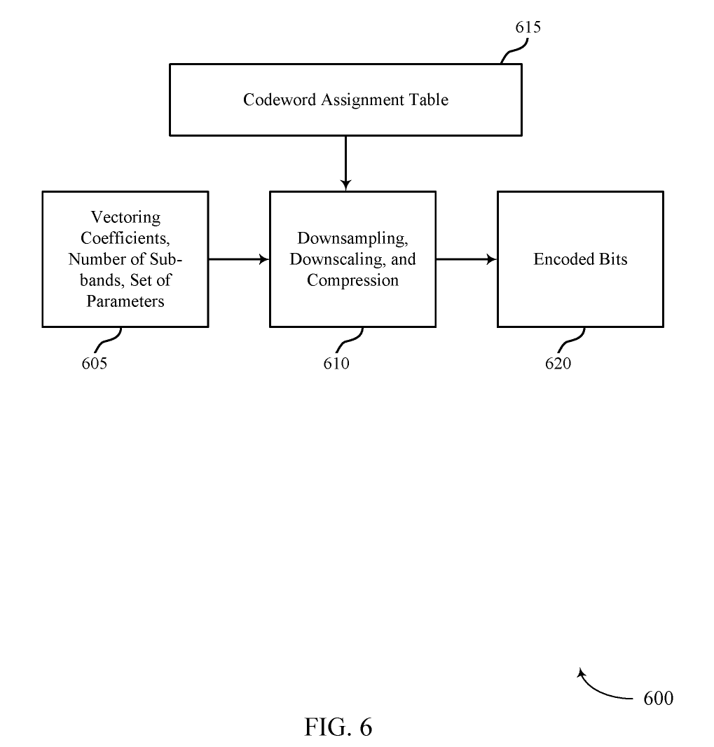

FIG. 6 illustrates a flow chart illustrating an example of a method 600 for techniques for processing and storing vectoring coefficients in accordance with various aspects of the present disclosure. For the purposes of illustration, the method 600 will be described as it relates to the components of the CO apparatus 505 shown in FIG. 5. This method 600 can may also be performed by the DSLAM 105, and DSLAM 205 shown in FIGS. 1-2, which may be examples of or components of the CO apparatus 505 shown in FIG. 5.

At block 605, a CO apparatus may determine a plurality of sets of vectoring coefficients (e.g., FEXT precoding and FEXT canceller coefficients), a number of sub-bands (e.g., a subset of tones), and a set of compression parameters as described above with reference to FIGS. 2 through 5. In certain examples, the operations of block 605 may be performed by the vectoring device(s) 220 or vectoring device(s) 560 as described with reference to FIGS. 2 and 5.

At block 610, a CO apparatus may perform downsampling of the plurality of sets of vectoring coefficients, where each set of vectoring coefficients may be associated with a pair of DSL lines and a subset of tones used to communicate data over the pair of DSL lines. In some cases the CO apparatus may quantize each set of vectoring coefficients and compress a set of change values for each set of downsampled and quantized vectoring coefficient as described above with reference to FIGS. 2 through 5. In certain examples, the operations of block 610 may be performed by the vectoring device(s) 220 or vectoring device(s) 560 as described with reference to FIGS. 2 and 5.

In some cases, a CO apparatus may use a codeword assignment table at block 615 to determine a codeword assignment for each change value according to a Golomb-Rice encoding scheme and change the codeword assignment for at least one of the change values based at least in part on a frequency of occurrence of the change value and a size of a codeword assigned to that change value using the Golomb-rice encoding scheme as described above with reference to FIGS. 2 through 5. In certain examples, the operations of block 615 may be performed by the vectoring device(s) 220 or vectoring device(s) 560 as described with reference to FIGS. 2 and 5.

At block 620, a CO apparatus may store the compressed sets of change values as encoded bits, where the compressed change values are used to perform vectoring over the DSL lines as described above with reference to FIGS. 2 through 5. In certain examples, the operations of block 620 may be performed by the compression coefficient storage 225 as described with reference to FIG. 2.

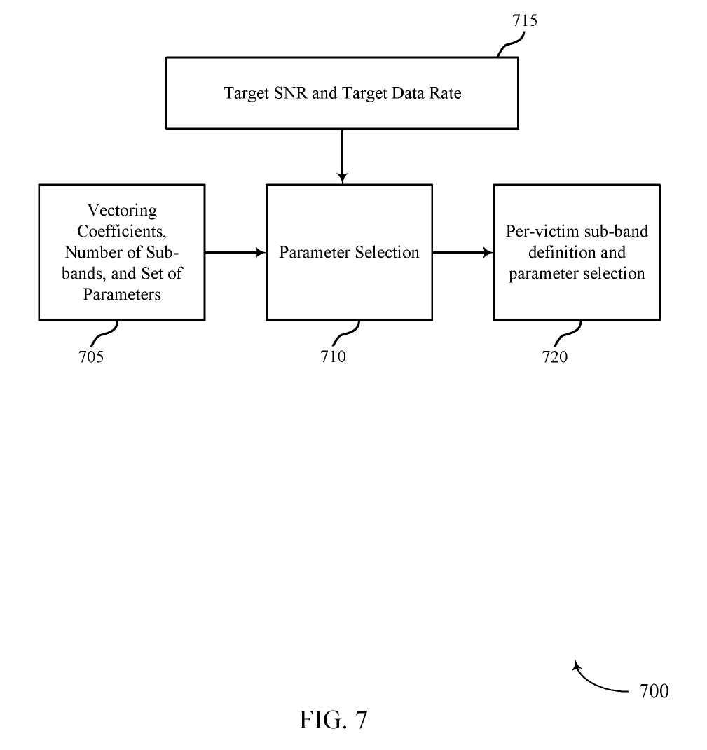

FIG. 7 illustrates a flow chart illustrating an example of a method 700 for techniques for processing and storing vectoring coefficients in accordance with various aspects of the present disclosure. For the purposes of illustration, the method 600 will be described as it relates to the components of the CO apparatus 505 shown in FIG. 5. This method 700 can may also be performed by the DSLAM 105, and DSLAM 205 shown in FIGS. 1-2, which may be examples of or components of the CO apparatus 505 shown in FIG. 5.

At block 705, a CO apparatus may determine a set of vectoring coefficients and a number of sub-bands (e.g., a subset of tones), as described above with reference to FIGS. 2 through 5. In certain examples, the operations of block 705 may be performed by the vectoring device(s) 220 or vectoring device(s) 560 as described with reference to FIGS. 2 and 5.

At block 710, a CO apparatus may determine a set of parameters (e.g., a downsampling parameter, a quantization parameter, and a compression parameter) as described above with reference to FIGS. 2 through 5. The set of parameters may correspond to one or more tones, one or more subbands, and/or the like. In certain examples, the operations of block 710 may be performed by the vectoring device(s) 220 or vectoring device(s) 560 as described with reference to FIGS. 2 and 5.

In some cases, a CO apparatus may identify a target SNR and a target data rate at block 715 to determine the set of parameters (e.g., a downsampling parameter, a quantization parameter, and a compression parameter) as described above with reference to FIGS. 2 through 5. In certain examples, the operations of block 615 may be performed by the FEXT detector 535 as described with reference to FIG. 5.

At block 720, a CO apparatus may define per-victim and per-sub-band parameters (e.g., F sub, k, and M parameters) and may store the selected parameters in a codeword assignment table as described above with reference to FIGS. 2 through 5. In certain examples, the operations of block 620 may be performed by the compression coefficient storage 225 as described with reference to FIG. 2.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. An apparatus for wireline communication, in a system comprising:
a processor;
memory in communication with the processor; and
instructions stored in the memory and operable, when executed by the processor, to cause the apparatus to:
select victim-disturber specific parameters corresponding to a pair of digital subscriber line (DSL) lines and a subset of tones used to communicate data over the pair of DSL lines;
downsample, based at least in part on a downsampling parameter of the victim-disturber specific parameters, a set of vectoring coefficients;
quantize the set of vectoring coefficients based at least in part on a quantization parameter of the victim-disturber specific compression parameters;
compress, based at least in part on a compression parameter of the victim-disturber specific compression parameters, a set of change values for the downsampled and quantized vectoring coefficients, the set of change values representing a difference between the downsampled and quantized vectoring coefficients across the subset of tones; and
use the compressed set of change values to perform vectoring over the pair of DSL lines.

2. The apparatus of claim 1, wherein the instructions are further executable by the processor to:
pack for storage the compressed set of change values for the downsampled and quantized vectoring coefficients.

3. The apparatus of claim 2, wherein the instructions are further executable by the processor to:
pack for storage a second compressed set of change values based at least in part on downsampling and quantization of a second set of vectoring coefficients, wherein the downsampling parameter differs from a second downsampling parameter used to downsample the second set of vectoring coefficients.

4. The apparatus of claim 1, wherein the instructions are further executable by the processor to:
select the downsampling parameter based at least in part on a variance of the set of vectoring coefficients.

5. The apparatus of claim 1, wherein the instructions are further executable by the processor to:
select the quantization parameter based at least in part on at least one from a group consisting of: a signal-to-noise ratio (SNR) associated with the set of vectoring coefficients or a downsampling parameter associated with the set of vectoring coefficients.

6. The apparatus of claim 1, wherein the instructions are further executable by the processor to:
select the compression parameter from a defined set of possible compression parameters, wherein the selection is based at least in part on a size of the compressed set of change values using the selected compression parameter in comparison to at least one other compression parameter from the defined set.

7. The apparatus of claim 1, wherein the set of change values is compressed using a codeword based compression.

8. The apparatus of claim 7, wherein compressing the set of change values comprises further instructions executable by the processor to:
determine a codeword assignment for each change value using a Golomb-Rice encoding scheme; and
change the codeword assignment for at least one of the set of change values based at least in part on a frequency of occurrence of the change value and a size of a codeword originally assigned to the change value using the Golomb-Rice encoding scheme.

9. The apparatus of claim 1, wherein the pair of DSL lines comprises a victim-disturber pair.

10. An apparatus for wireline communication, comprising:
means for selecting victim-disturber specific parameters corresponding to a pair of digital subscriber line (DSL) lines and a subset of tones used to communicate data over the pair of DSL lines;
means for downsampling, based at least in part on a downsampling parameter of the victim-disturber specific parameters, a set of vectoring coefficients;
means for quantizing the set of vectoring coefficients based at least in part on a quantization parameter of the victim-disturber specific compression parameters;
means for compressing, based at least in part on a compression parameter of the victim-disturber specific compression parameters, a set of change values for the downsampled and quantized vectoring coefficients, the set of change values representing a difference between the downsampled and quantized vectoring coefficients across the subset of tones; and
means for using the compressed sets of change values to perform vectoring over the pair of DSL lines.

11. The apparatus of claim 10, further comprising:
means for packing for storage the compressed set of change values for the downsampled and quantized vectoring coefficients.

12. The apparatus of claim 11, further comprising:
means for packing for storage a second compressed set of change values based at least in part on downsampling and quantization of a second set of vectoring coefficients, wherein the downsampling parameter differs from a second downsampling parameter used to downsample the second set of vectoring coefficients.

13. The apparatus of claim 10, further comprising:
means for selecting the downsampling parameter based at least in part on a variance of the set of vectoring coefficients.

14. The apparatus of claim 10, further comprising:
means for selecting the quantization parameter based at least in part on at least one from a group consisting of: a signal-to-noise ratio (SNR) associated with the set of vectoring coefficients or a downsampling parameter associated with the set of vectoring coefficients.

15. The apparatus of claim 10, further comprising:
means for selecting the compression parameter from a defined set of possible compression parameters, wherein the selection is based at least in part on a size of the compressed sets of change values using the selected compression parameter in comparison to at least one other compression parameter from the defined set.

16. The apparatus of claim 10, wherein the set of change values is compressed using a codeword based compression.

17. The apparatus of claim 16, wherein the means for compressing the set of change values comprises:
means for determining a codeword assignment for each change value using a Golomb-Rice encoding scheme; and
means for changing the codeword assignment for at least one of the set of change values based at least in part on a frequency of occurrence of the change value and a size of a codeword originally assigned to the change value using the Golomb-Rice encoding scheme.

18. The apparatus of claim 10, wherein the pair of DSL lines comprises a victim-disturber pair.

19. A wireline communication device, comprising:
a parameter selector to select victim-disturber specific parameters corresponding to a pair of digital subscriber line (DSL) lines and a subset of tones used to communicate data over the pair of DSL lines;
a downsampler to downsample a set of vectoring coefficients based at least in part on a downsampling parameter of the victim-disturber specific parameters;
a quantizer to quantize the set of vectoring coefficients based at least in part on a quantization parameter of the victim-disturber specific compression parameters;
a compressor to compress, based at least in part on a compression parameter of the victim-disturber specific compression parameters, a set of change values for the set of downsampled and quantized vectoring coefficients, the set of change values representing a difference between the downsampled and quantized vectoring coefficients across the subset of tones; and
a compensation block to perform vectoring over the pair of DSL lines using the compressed set of change values.

20. The wireline communication device of claim 19, further comprising:
a packer to pack for storage the compressed set of change values for the downsampled and quantized vectoring coefficients.

21. The wireline communication device of claim 20, wherein the instructions are further executable by the processor to:
a packer to pack for storage a second compressed set of change values based at least in part on downsampling and quantization of a second set of vectoring coefficients, wherein the downsampling parameter differs from a second downsampling parameter used to downsample the second set of vectoring coefficients.

22. The wireline communication device of claim 19, the parameter selector to select the downsampling parameter for the set of vectoring coefficients based at least in part on a variance of the set of vectoring coefficients.

23. The wireline communication device of claim 19, the parameter selector to select the quantization parameter for the set of vectoring coefficients based at least in part on at least one from a group consisting of: a signal-to-noise ratio (SNR) associated with the set of vectoring coefficients or a downsampling parameter associated with the set of vectoring coefficients.

24. The wireline communication device of claim 19, the parameter selector to select the compression parameter from a defined set of possible compression parameters, wherein the selection is based at least in part on a size of the compressed set of change values using the selected compression parameter in comparison to at least one other compression parameter from the defined set.

25. The wireline communication device of claim 19, wherein the set of change values is compressed for the set of downsampled and quantized vectoring coefficients using a codeword based compression.

26. The wireline communication device of claim 25, the compressor to:
determine a codeword assignment for each change value using a Golomb-Rice encoding scheme; and
change the codeword assignment for at least one of the set of change values based at least in part on a frequency of occurrence of the change value and a size of a codeword originally assigned to the change value using the Golomb-Rice encoding scheme.

27. The wireline communication device of claim 19, wherein the pair of DSL lines comprises a victim-disturber pair.

28. A method of performing wireline communications, comprising:
selecting victim-disturber specific parameters corresponding to a pair of digital subscriber line (DSL) lines and a subset of tones used to communicate data over the pair of DSL lines;
downsampling, based at least in part on a downsampling parameter of the victim-disturber specific parameters, a set of vectoring coefficients;
quantizing the set of vectoring coefficients based at least in part on a quantization parameter of the victim-disturber specific compression parameters;
compressing, based at least in part on a compression parameter of the victim-disturber specific compression parameters, a set of change values for the set of downsampled and quantized vectoring coefficients, the set of change values representing a difference between the downsampled and quantized vectoring coefficients across the subset of tones; and
using the compressed sets of change values to perform vectoring over the pair of DSL lines.

29. The method of claim 19, further comprising:
packing for storage the compressed set of change values for the downsampled and quantized vectoring coefficients.

30. The method of claim 20, further comprising:
packing for storage a second compressed set of change values based at least in part on downsampling and quantization of a second set of vectoring coefficients, wherein the downsampling parameter differs from a second downsampling parameter used to downsample the second set of vectoring coefficients.

31. The method of claim 28, further comprising:
selecting the downsampling parameter for the set of vectoring coefficients based at least in part on a variance of the set of vectoring coefficients.

32. The method of claim 28, further comprising:
selecting the quantization parameter for the set of vectoring coefficients based at least in part on at least one from a group consisting of: a signal-to-noise ratio (SNR) associated with the set of vectoring coefficients or a downsampling parameter associated with the set of vectoring coefficients.

33. The method of claim 28, further comprising:
selecting the compression parameter from a defined set of possible compression parameters, wherein the selection is based at least in part on a size of the compressed set of change values using the selected compression parameter in comparison to at least one other compression parameter from the defined set.

34. The method of claim 28, wherein the set of change values is compressed for the set of downsampled and quantized vectoring coefficients using a codeword based compression.

35. The method of claim 34, wherein compressing the set of change values comprises:
determining a codeword assignment for each change value using a Golomb-Rice encoding scheme; and
changing the codeword assignment for at least one of the set of change values based at least in part on a frequency of occurrence of the change value and a size of a codeword originally assigned to the change value using the Golomb-Rice encoding scheme.

36. The method of claim 28, wherein the pair of DSL lines comprises a victim-disturber pair.

37. A non-transitory computer readable medium storing code for wireline communication, the code comprising instructions executable by a processor to:
select victim-disturber specific parameters corresponding to a pair of digital subscriber line (DSL) lines and a subset of tones used to communicate data over the pair of DSL lines;
downsample, based at least in part on a downsampling parameter of the victim-disturber specific parameters, a set of vectoring coefficients;
quantize the set of vectoring coefficients based at least in part on a quantization parameter of the victim-disturber specific compression parameters;
compress, based at least in part on a compression parameter of the victim-disturber specific compression parameters, a set of change values for the set of downsampled and quantized vectoring coefficients, the set of change values representing a difference between the downsampled and quantized vectoring coefficients across the subset of tones; and
use the compressed sets of change values to perform vectoring over the pair of DSL lines.

38. The non-transitory computer-readable medium of claim 37, wherein the instructions are further executable by the processor to:
select the downsampling parameter for the set of vectoring coefficients based at least in part on a variance of the set of vectoring coefficients.
